(19) United States
(12) Patent Application Publication
(10) Pub. No.: US 2026/0202605 A1
(43) Pub. Date: Jul. 16, 2026

(54) DUAL-MODE LIQUID CRYSTAL DISPLAY COMPATIBLE WITH NIGHT VISION FUNCTION

(71) Applicant: EMERGING DISPLAY TECHNOLOGIES CORP., Kaohsiung City (TW)

(72) Inventors: PO TSUN LIU, Kaohsiung City (TW); HONG LUN SIAO, Kaohsiung City (TW); CHAO PING WU, Kaohsiung City (TW)

(21) Appl. No.: 19/022,003

(22) Filed: Jan. 15, 2025

(51) Int. Cl. F21V 8/00; G02F 1/1333; G02F 1/1335; G02F 1/13357

(52) U.S. Cl. CPC G02B 6/0036; G02B 6/0073; G02F 1/13338; G02F 1/133524; G02F 1/133615

(57) ABSTRACT

A dual-mode LCD compatible with night vision function includes an LCD panel and a backlight unit. The backlight unit is mounted on a rear side of the LCD panel, and includes a light guide plate, a first light source group, and a second light source group. The first light source group emits a first light in a first display mode (e.g., daytime mode), providing normal backlighting for the LCD panel to display standard colors. The second light source group emits a second light in a second display mode (e.g., night vision mode). A near-infrared light in the second light is filtered out. As a result, the LCD panel in the second display mode can reduce the interference caused by near-infrared light, allowing for clear display of images in low-light environments.

### BACKGROUND OF THE INVENTION

### 1. Field of the Invention

This invention relates to an LCD, specifically to an LCD that can switch light sources according to surrounding environment to meet the viewing needs in different environments.

### 2. Description of the Related Art

Over the past few decades of research and development, LCD (Liquid Crystal Display) has become a mainstream display technology in modern electronic devices due to its superior flatness, energy efficiency, and wide viewing angles. Applications of the LCD are vast, ranging from personal computers to large televisions, and further from handheld devices to professional monitors.

The LCD can also be used in conjunction with Night Vision Imaging Systems (NVIS). A working principle of the NVIS is to use image enhancement and photoelectric conversion technologies to amplify and convert near-infrared light (610 nm to 930 nm) that is invisible to the human eyes or has low visibility into visible images. In other words, the NVIS is highly sensitive to near-infrared light sources. To reduce the interference of near-infrared light on the LCD, as shown in FIG. 19, a conventional LCD typically consists of an LCD panel 100 and a backlight module 200. Currently, an optical adhesive 300 is used to attach a filter 400 to a light-emitting surface of the LCD panel 100, and the filter 400 is designed to filter or absorb the near-infrared light energy produced by the backlight module 200.

Although placing the filter 400 can reduce the near-infrared light emitted by the backlight module 200 in low-light environments (such as at night), when an ambient light source is stronger (such as during the day), a brightness of the LCD is affected by the filter 400. The overall light emission efficiency is reduced, leading to a dimmer viewing experience. Furthermore, since near-infrared light is absorbed, the LCD cannot display full-color images properly.

### SUMMARY OF THE INVENTION

In light of the above, the present invention provides a dual-mode LCD compatible with night vision function, and the dual-mode LCD can switch between night vision imaging display and daytime imaging display according to user's needs.

To achieve above objective, the dual-mode LCD compatible with night vision function includes an LCD panel and a backlight unit. The LCD panel has a front side and a rear side. The backlight unit is mounted on the rear side of the LCD panel, and the backlight unit includes at least one light guide plate, a first light source group, and a second light source group. The light guide plate has a light-emitting surface facing the rear side of the LCD panel. The first light source group is configured to emit a first light towards the at least one light guide plate in a first display mode. The second light source group is configured to emit a second light towards the at least one light guide plate in a second display mode. A near-infrared light in the second light is filtered out.

In the present invention, different light source groups are arranged in the backlight unit, with each corresponding light source group being activated for different display modes. For non-night vision imaging needs, the first light source group generates the first light which is unfiltered, and the LCD panel uses the first light as the backlight to display standard color images. For night vision imaging needs, the second light source group generates the second light which is filtering out the near-infrared light. The LCD panel uses the second light which is filtered as the backlight to display night vision images. Therefore, the night vision images may not be interfered by the near-infrared light, thereby improving imaging quality.

### BRIEF DESCRIPTION OF THE DRAWINGS

FIG. 1 is a schematic exploded diagram of a first embodiment of the present invention.

FIG. 2 is an operational diagram of a first light source of the first embodiment applied in a first display mode (daytime mode).

FIG. 3 is an operational diagram of a second light source of the first embodiment applied in a second display mode (night vision mode).

FIG. 4 is a schematic exploded diagram of a second embodiment of the present invention.

FIG. 5 is an operational diagram of the first light source of the second embodiment applied in the first display mode (daytime mode).

FIG. 6 is an operational diagram of the second light source of the second embodiment applied in the second display mode (night vision mode).

FIG. 7 is a schematic diagram of a first micro-prism used in the present invention.

FIG. 8 is a schematic diagram of a second micro-prism used in the present invention.

FIG. 9 is a schematic exploded diagram of a third embodiment of the present invention.

FIG. 10 is an operational diagram of a first light source of the third embodiment applied in a first display mode (daytime mode).

FIG. 11 is an operational diagram of a second light source of the third embodiment applied in a second display mode (night vision mode).

FIG. 12 is a schematic exploded diagram of a fourth embodiment of the present invention.

FIG. 13 is an operational diagram of a first light source of the fourth embodiment applied in a first display mode (daytime mode).

FIG. 14 an operational diagram of a second light source of the fourth embodiment applied in a second display mode (night vision mode).

FIG. 15 is an operational diagram of a first light source of a fifth embodiment applied in a first display mode (daytime mode).

FIG. 16 an operational diagram of a second light source of the fifth embodiment applied in a second display mode (night vision mode).

FIG. 17 is a schematic diagram of a distribution density of microstructures of a light guide plate of the present invention.

FIG. 18 is a schematic diagram of the present invention attached with a capacitive touch panel (CTP).

FIG. 19 is a schematic diagram of a light-emitting surface of an LCD attached with a filter.

### DETAILED DESCRIPTION OF THE INVENTION

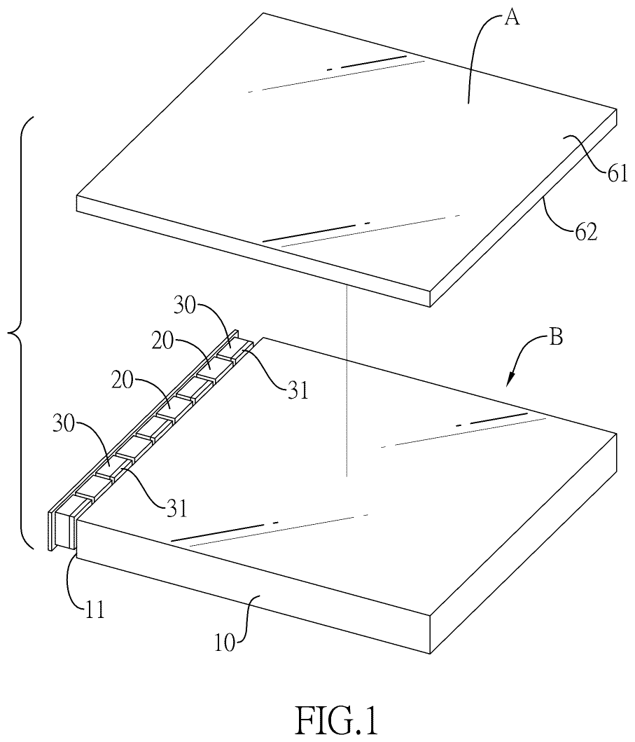

FIGS. 1 to 3 show schematic exploded views of a dual-mode LCD compatible with night vision function of a first embodiment of the present invention. The dual-mode LCD includes an LCD panel A and a backlight unit B. The LCD panel A is made up of multiple layers, such as a liquid crystal layer, color filters, upper/lower polarizers, thin-film transistor control layers, etc. The present invention does not focus on the LCD panel A, so it will not be elaborated further. The LCD panel A has a front side 61 and a rear side 62. The front side 61 refers to a side facing a user for viewing, and the rear side 62 refers to a side facing the backlight unit B.

The backlight unit B is positioned on the rear side 62 of the LCD panel A to provide a light source for the LCD panel A. The backlight unit B includes at least one light guide plate 10, a first light source group, and a second light source group. The first light source group is configured to emit a first light towards the light guide plate 10 in a first display mode. The second light source group is configured to emit a second light towards the light guide plate in a second display mode. A near-infrared light (wavelength between 610 nm and 930 nm) in the second light is filtered out. Therefore, in the first display mode, such as a bright environment or a daytime mode, the first light source group is activated to provide a normal light source to the LCD panel A, allowing the LCD to display full-color images. On the other hand, in the second display mode, such as a low-light environment or a night vision mode, the second light source group is activated to provide a light source to the LCD panel A, and the second light has the near-infrared light filtered out. Namely, in the second display mode, the LCD panel A is suitable for use in a night vision imaging system (NVIS) and avoiding interference from the near-infrared light.

In the first embodiment shown in FIG. 1, the backlight unit B includes a single light guide plate 10. The light guide plate 10 is a flat light guide plate, meaning an upper surface and a lower surface of the light guide plate 10 are parallel flat surfaces. One side of the light guide plate 10 is a light incident side 11.

The first light source group includes multiple first light-emitting elements 20. The first light-emitting elements 20 can be mounted on a flexible circuit board near the light incident side 11 of the light guide plate 10. Each of the first light-emitting elements 20 is a white light LED, and light-emitting surfaces of the first-emitting elements 20 face the light incident side 11 of the light guide plate 10.

The second light source group includes multiple second light-emitting elements 30. The second light-emitting elements 30 are similarly mounted near the light incident side 11 of the light guide plate 10, and are arranged alternately with the first light-emitting elements 20. In this embodiment, each of the second light-emitting elements 30 includes a white light LED and a filter 31. The filter 31 is positioned on a light-emitting surface of the white light LED of the second light-emitting element 30 to filter out the near-infrared light.

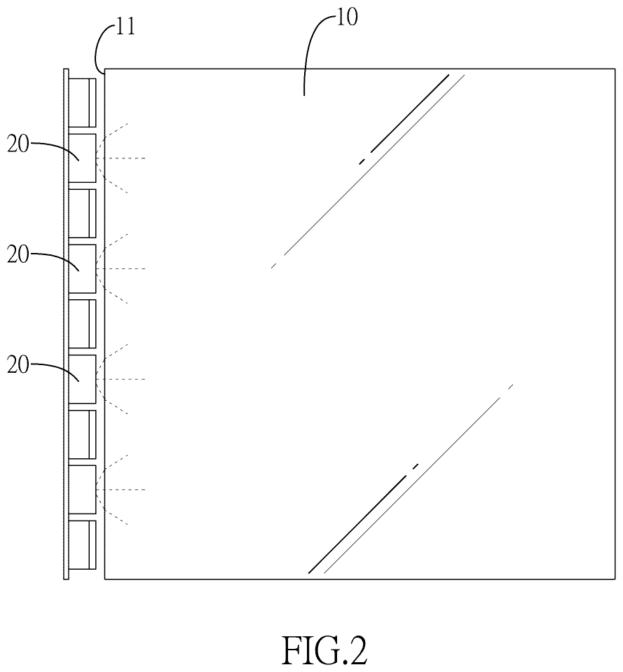

When the LCD is operated in the first display mode, as shown in FIG. 2, only the first light-emitting elements 20 emit white light, but the second light-emitting elements 30 do not emit light. When the white light enters the light guide plate 10, the light guide plate 10 generates a uniform white backlight, such that the LCD panel A displays standard colors correctly.

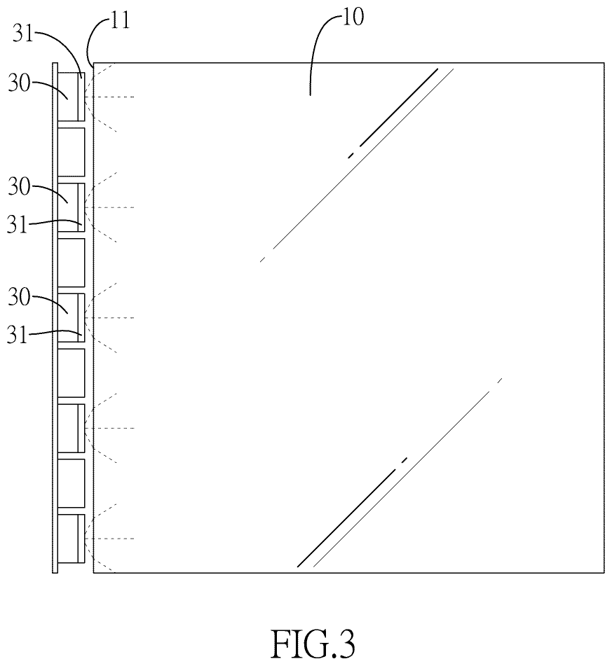

As shown in FIG. 3, when the LCD is operated in the second display mode, the first light-emitting elements 20 do not emit light. Instead, the second light-emitting elements 30 emit light, and the light emitted by the second light-emitting elements 30 passes through the filters 31 to filter light having specific wavelengths. When the filtered light enters the light guide plate 10, the light guide plate 10 produces a uniform filtered backlight. In this case, even when the LCD panel A operates in a night vision mode, the LCD panel A is not affected by near-infrared light interference from the light source.

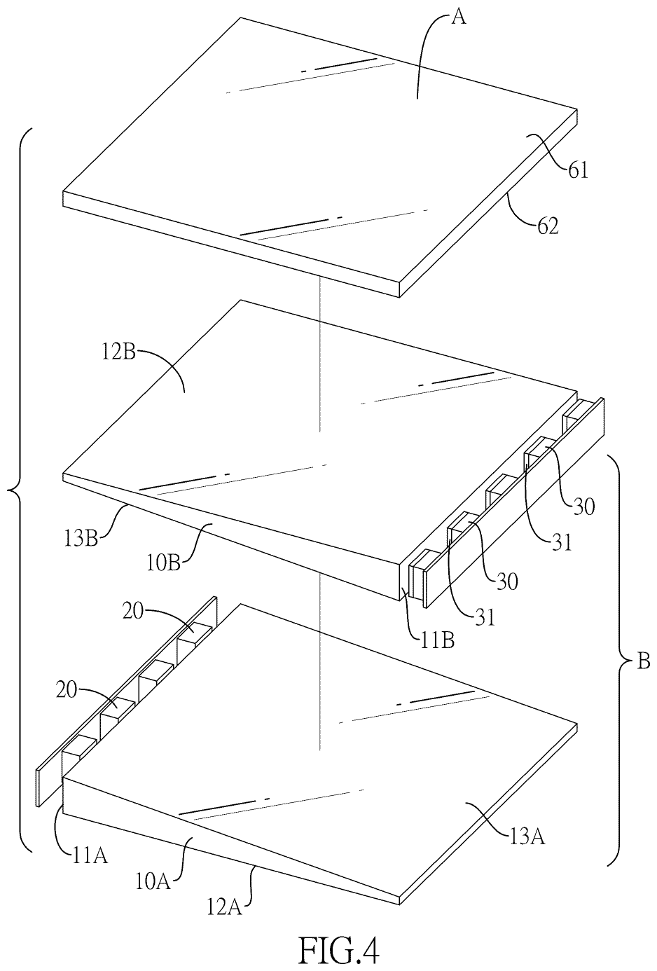

FIGS. 4 to 6 show a second embodiment of the present invention. In this embodiment, the backlight unit B includes a first light guide plate 10A and a second light guide plate 10B, and both of the first light guide plate 10A and the second light guide plate 10B are wedge-shaped light guide plates.

The first light guide plate 10A has a light incident side 11A, a first surface 12A, and a first inclined surface 13A. The first surface 12A is opposite to the first inclined surface 13A. The first inclined surface 13A is inclined relative to the first surface 12A. A thickness of the first light guide plate 10A gradually decreases as it extends from the light incident side 11A towards a side opposite to the light incident side 11A. A plurality of dots 14A are formed on the first surface 12A. The dots 14A disrupt the total internal reflection of light within the first light guide plate 10A, allowing light to be directed towards the first inclined surface 13A. The first inclined surface 13A is a light-emitting surface of the first light guide plate 10A. The first inclined surface 13A faces the second light guide plate 10B, and also faces the rear side 62 of the LCD panel A.

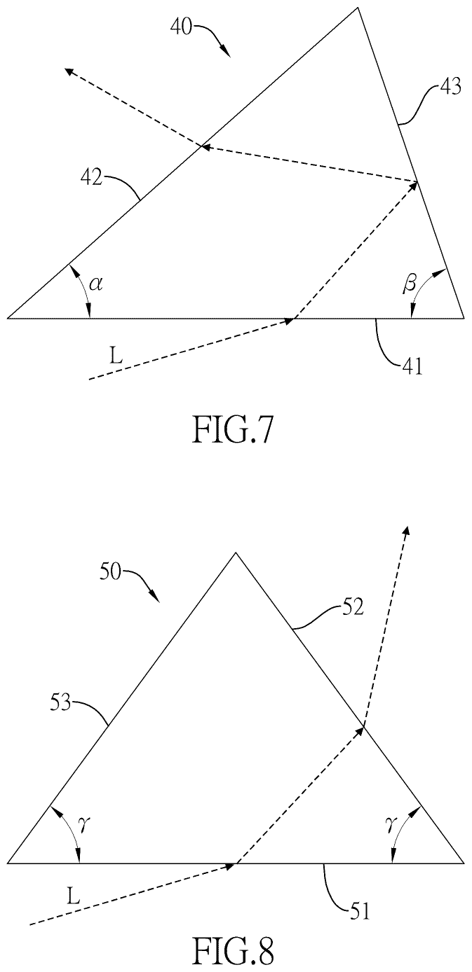

The first inclined surface 13A is formed with multiple first microprisms 40 protruding from the first inclined surface 13A. As shown in FIG. 7, each of the first microprisms 40 is a triangular prism structure, and includes a base surface 41, a first prism surface 42, and a second prism surface 43. The base surface 41 is coplanar with the first inclined surface 13A of the first light guide plate 10A. The first prism surface 42 faces the light incident side 11A. The second prism surface 43 faces away from the light incident side 11A. A first angle α is formed between the first prism surface 42 and the base surface 41. A second angle β is formed between the second prism surface 43 and the base surface 41. The first angle α is smaller than the second angle β (α<β). This angular design redirects some of the light L that passes through the first light guide plate 10A back to a vertical light-emitting position of the first light guide plate 10A, such as the first prism surface 42, thereby increasing brightness of the light output from the first light guide plate 10A.

The second light guide plate 10B has a light incident side 11B, a second surface 12B, and a second inclined surface 13B. The second surface 12B is opposite to the second inclined surface 13B. The second inclined surface 13B is inclined relative to the second surface 12B. A thickness of the second light guide plate 10B gradually decreases as it extends from the light incident side 11B towards a side opposite to the light incident side 11B. A plurality of dots 14B are formed on the second inclined surface 13B. Similarly, these dots 14B disrupt the total internal reflection of light within the second light guide plate 10B, allowing the light to be more concentrated and emitted from the second surface 12B. The second surface 12B is a light-emitting surface of the second light guide plate 10B. The second surface 12B faces the rear side 62 of the LCD panel A.

Multiple second microprisms 50 are formed on the second surface 12B, as shown in FIG. 8. Each of the second microprisms 50 is a triangular prism structure. In one embodiment, the triangular prism is an isosceles triangular prism, and has a base surface 51, a first prism surface 52, and a second prism surface 53. The base surface 51 is coplanar with the second surface 12B of the second light guide plate 10B. The first prism surface 52 faces the light incident side 11B. The second prism surface 53 faces away from the light incident side 11B. An angle γ is formed between the first prism surface 52 and the base surface 51, and another angle γ is formed between the second prism surface 53 and the base surface 51. The two angles γ are equal.

The first light source group includes multiple first light-emitting elements 20. The first light-emitting elements 20 are mounted near the light incident side 11A of the first light guide plate 10A. Each of the first light-emitting elements 20 is a white light LED.

The second light source group includes multiple second light-emitting elements 30. The second light-emitting elements 30 are mounted near the light incident side 11B of the second light guide plate 10B. Each of the second light-emitting elements 30 includes a white light LED and a filter 31. The filter 31 is placed on a light-emitting surface of the white light LED to filter out the near-infrared light.

Since the light incident side 11A of the first light guide plate 10A and the light incident side 11B of the second light guide plate 10B are located on opposite sides, the first light source group and the second light source group are also located on opposite sides.

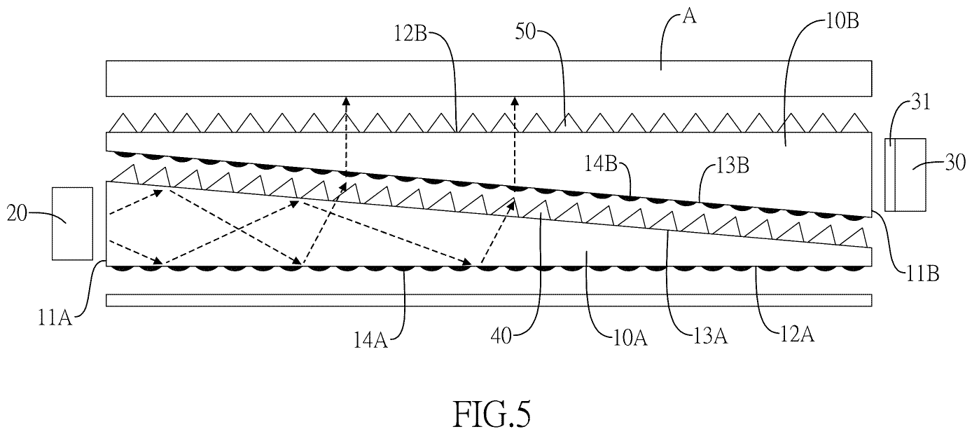

When the LCD operates in the first display mode, as shown in FIG. 5, the multiple first light-emitting elements 20 emit white light, but the second light-emitting elements 30 do not emit light. The white light enters the first light guide plate 10A, and the first light guide plate 10A generates a uniform backlight. The uniform backlight is emitted from the first inclined surface 13A, is refracted by the multiple first microprisms 40, and then enters the second inclined surface 13B of the second light guide plate 10B. The uniform backlight then passes through the second microprisms 50 of the second light guide plate 10B, and emits to the LCD panel A, allowing the LCD panel A to display standard colors properly.

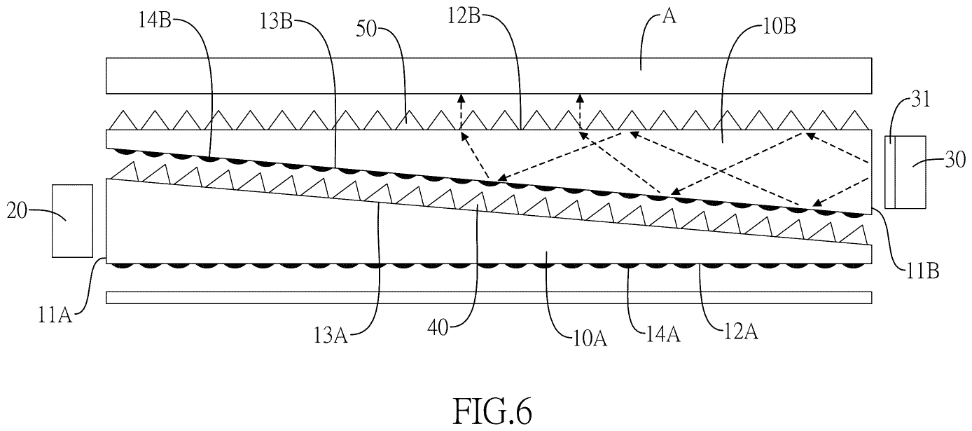

When the LCD operates in the second display mode, as shown in FIG. 6, the multiple first light-emitting elements 20 do not emit light. Instead, the multiple second light-emitting elements 30 emit light, and the light from the second light-emitting elements 30 passes through the filter 31 to filter light having specific wavelengths. The filtered light enters the second light guide plate 10B, and the second light guide plate 10B generates a uniform backlight. The uniform backlight is emitted from the second surface 12B to the LCD panel A. Even when the LCD panel A is operating in a night vision mode, the LCD panel A will not be affected by the near-infrared light interference from the light source.

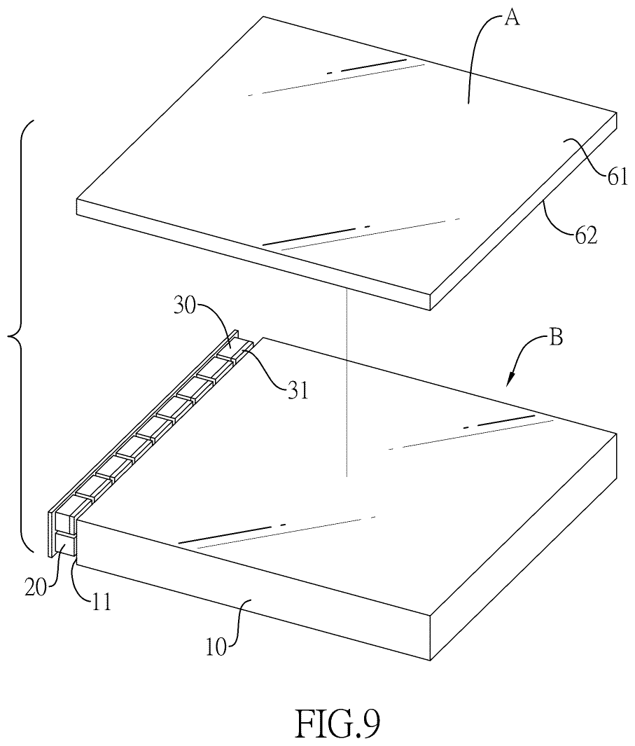

FIGS. 9 to 11 show a third embodiment of the present invention. In the third embodiment shown in FIG. 9, the backlight unit B includes a single light guide plate 10. The light guide plate 10 is a flat light guide plate, meaning an upper surface and a lower surface of the light guide plate 10 are parallel flat surfaces. One side of the light guide plate 10 is a light incident side 11.

The first light source group includes multiple first light-emitting elements 20. The first light-emitting elements 20 can be mounted on a flexible circuit board near the light incident side 11 of the light guide plate 10. Each of the first light-emitting elements 20 is a white light LED, and light-emitting surfaces of the first-emitting elements 20 face the light incident side 11 of the light guide plate 10.

The second light source group includes multiple second light-emitting elements 30. The second light-emitting elements 30 are similarly mounted near the light incident side 11 of the light guide plate 10. The first light-emitting elements 20 and the second light-emitting elements 30 are arranged in two rows, and the first light-emitting elements 20 are arranged below the second light-emitting elements 30. In this embodiment, each of the second light-emitting elements 30 includes a white light LED and a filter 31. The filter 31 is positioned on a light-emitting surface of the white light LED of the second light-emitting element 30 to filter out the near-infrared light.

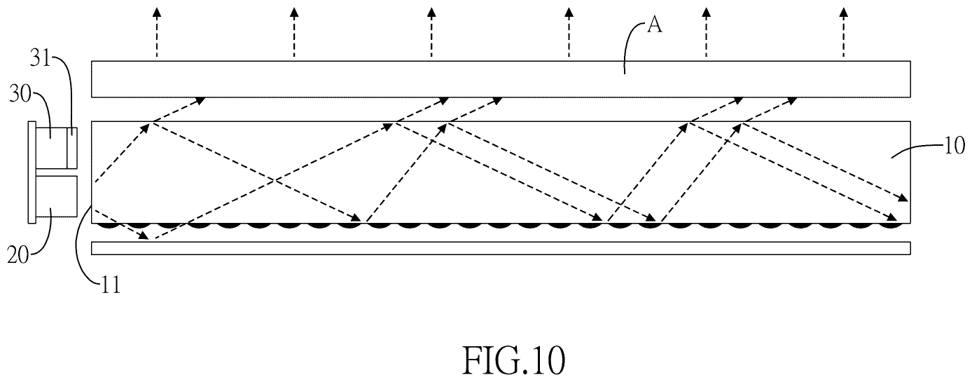

When the LCD is operated in the first display mode, as shown in FIG. 10, only the first light-emitting elements 20 emit white light, but the second light-emitting elements 30 do not emit light. When the white light enters the light guide plate 10, the light guide plate 10 generates a uniform white backlight, such that the LCD panel A displays standard colors correctly.

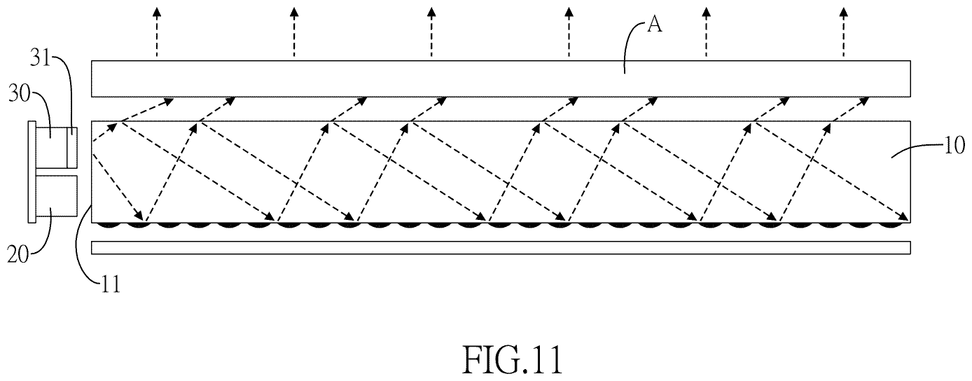

As shown in FIG. 11, when the LCD is operated in the second display mode, the first light-emitting elements 20 do not emit light. Instead, the second light-emitting elements 30 emit light, and the light emitted by the second light-emitting elements 30 passes through the filters 31 to filter light having specific wavelengths. When the filtered light enters the light guide plate 10, the light guide plate 10 produces a uniform filtered backlight. In this case, even when the LCD panel A operates in a night vision mode, the LCD panel A is not affected by near-infrared light interference from the light source.

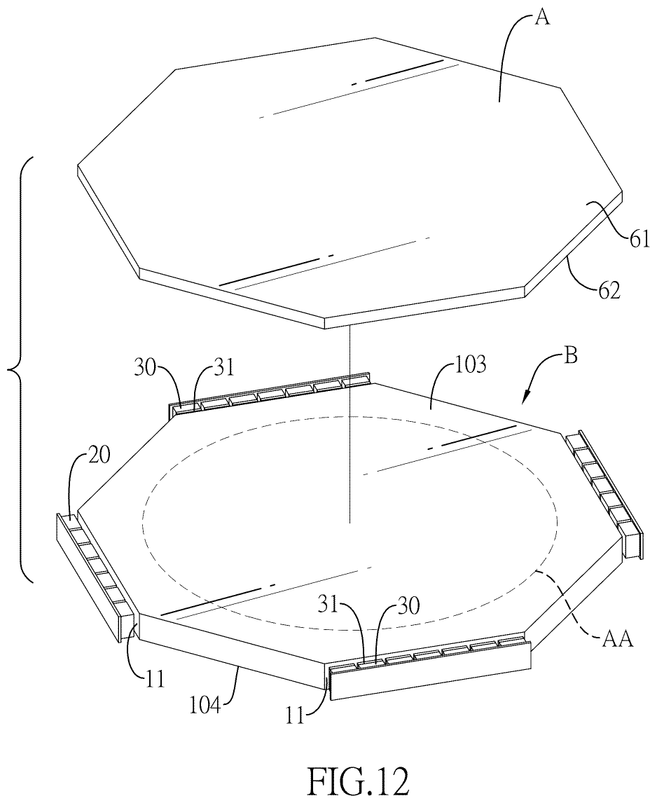

FIGS. 12 to 14 show a fourth embodiment of the present invention. The light guide plate 10 of the backlight unit B is a polygonal flat light guide plate, meaning an upper surface and a lower surface of the light guide plate 10 are parallel flat surfaces, and the upper surface and the lower surface are polygons. The light guide plate 10 includes two opposite first sides 101 and two opposite second sides 102.

In the embodiment, the light guide plate 10 is an octagonal flat guide plate. Namely, the upper surface and the lower surface of the light guide plate 10 are octagons. The two first sides 101 and the two second sides 102 are light incident sides 11. Namely, the light guide plate 10 includes four light incident sides 11.

The first light source group includes multiple first light-emitting elements 20. The first light-emitting elements 20 are mounted near the two first sides 101 of the light guide plate 10. Each of the first light-emitting elements 20 is a white light LED.

The second light source group includes multiple second light-emitting elements 30. The second light-emitting elements 30 are mounted near the two opposite second sides 102 of the light guide plate 10. Each of the second light-emitting elements 30 includes a white light LED and a filter 31. The filter 31 is placed on a light-emitting surface of the white light LED to filter out the near-infrared light.

Since the two opposite first sides 101 are located on opposite sides of the light guide plate 10, the first light source group is evenly separated to the opposite sides. Similarly, the two opposite second sides 102 are located on another two opposite sides of the light guide plate 10, and the second light source group is also evenly separated to another two opposite sides.

Furthermore, since the light guide plate 10 is the octagonal flat guide plate, the two opposite first sides 101 and the two opposite second sides 102 are spaced apart and are not adjacent to each other. Further, the two opposite first sides 101 are arranged alternately with the two opposite second sides 102.

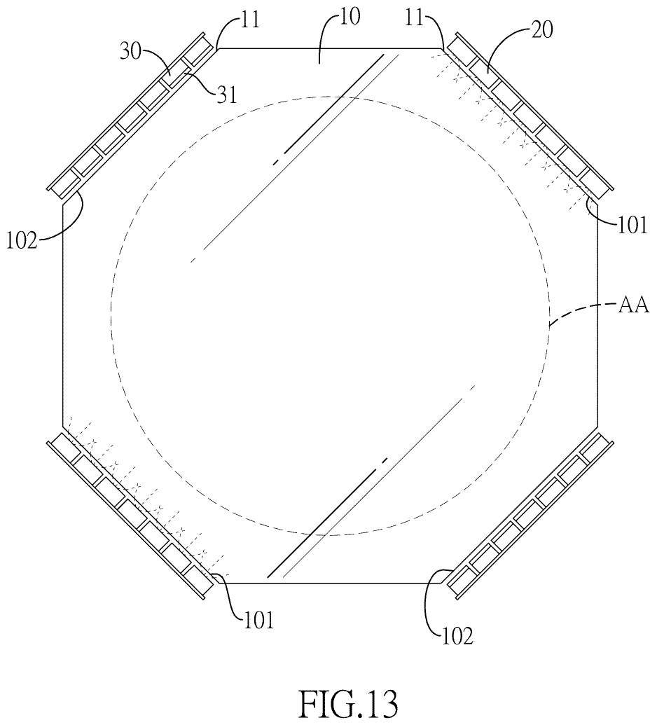

When the LCD operates in the first display mode, as shown in FIG. 13, the multiple first light-emitting elements 20 emit white light, but the second light-emitting elements 30 do not emit light. The white light enters the light guide plate 10, and the light guide plate 10 generates a uniform backlight. The uniform backlight is emitted from the upper surface of the light guide plate 10 to the LCD panel A, allowing the LCD panel A to display standard colors properly.

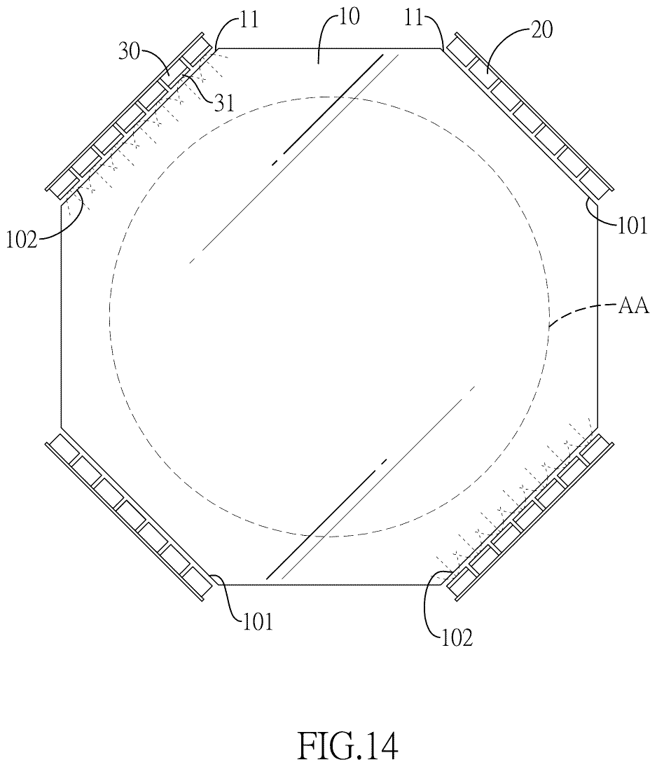

When the LCD operates in the second display mode, as shown in FIG. 14, the multiple first light-emitting elements 20 do not emit light. Instead, the multiple second light-emitting elements 30 emit light, and the light from the second light-emitting elements 30 passes through the filter 31 to filter light having specific wavelengths. The filtered light enters the light guide plate 10, and the light guide plate 10 generates a uniform backlight. The uniform backlight is emitted from the upper surface of the light guide plate 10 to the LCD panel A. Even when the LCD panel A is operating in a night vision mode, the LCD panel A will not be affected by the near-infrared light interference from the light source.

In this embodiment, the first light source group and the second light source group are both mounted in the light guide plate 10. Further, the first light source group and the second light source group are arranged at diagonal positions of the light guide plate 10, and are arranged symmetrically, as shown in FIGS. 13 and 14. Therefore, the dual-mode LCD not only avoids optically poor appearance of “hot spots” in an active area AA of the dual-mode LCD, but also reduces a number of the first light-emitting elements 20 and the second light-emitting elements 30, thereby reducing cost. Moreover, since the light guide plate 10 is designed to be a regular octagon, the light guide plate 10 can have a better performance for a circular display or a square display, and an overall thickness of the dual-mode LCD can also be reduced.

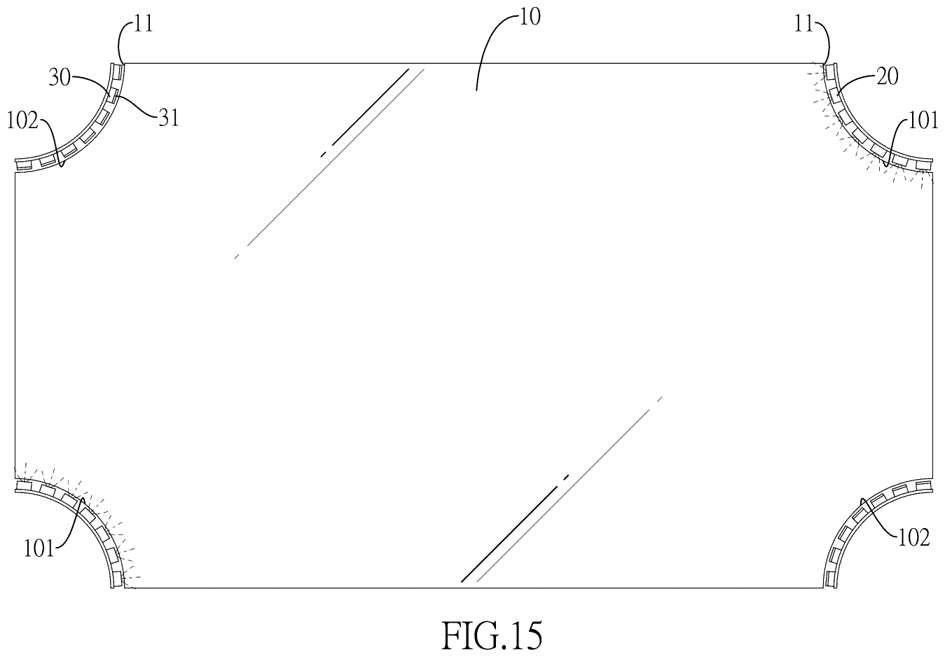

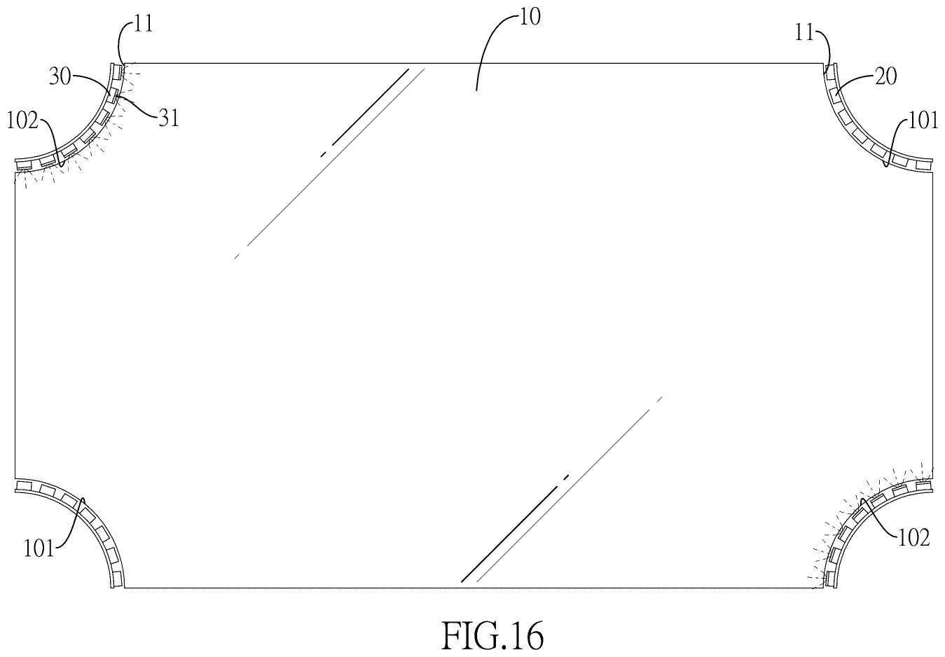

FIGS. 15 to 16 show a fifth embodiment of the present invention. The fifth embodiment is similar with the fourth embodiment. A difference between the fifth embodiment and the fourth embodiment is that the two opposite first sides 101 and the two opposite second sides 102 are respectively concaved to a central position of the light guide plate 10, and the two opposite first sides 101 and the two opposite second sides 102 are each in an arc shape.

When the light guide plate 10 is designed with an aspect ratio of 16:9, a path of the light is farther than that of a regular octagonal light guide plate, and an energy loss is also greater. Further, there will be “dark bands” on the light guide plate 10, and may result in poor viewing of the dual-mode LCD. Therefore, in this embodiment, a light entrance is designed in an arc-like arrangement. This method can maximize an angle at which the light enters the light guide plate 10 in a limited space, thereby eliminating the “dark band” on the light guide plate 10. Namely, for a design of the dual-mode LCD that requires non-rectangular active area AA, the viewing of the dual-mode LCD will be greatly optimized.

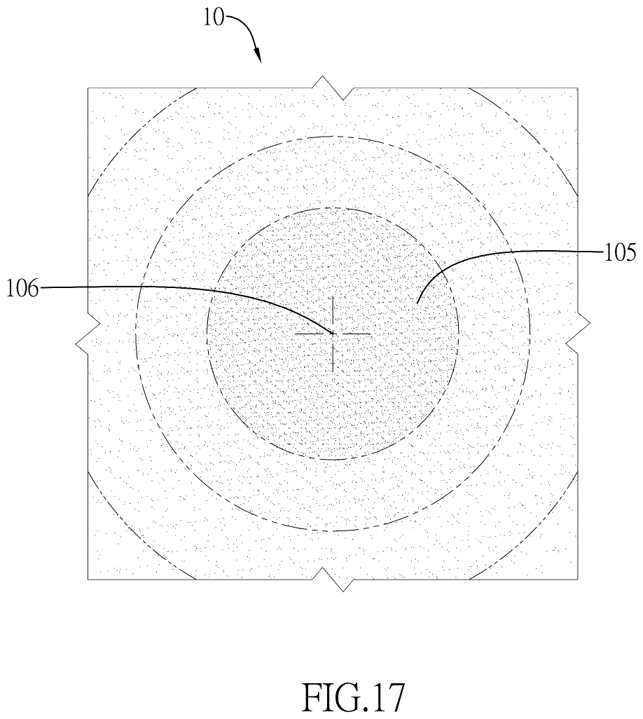

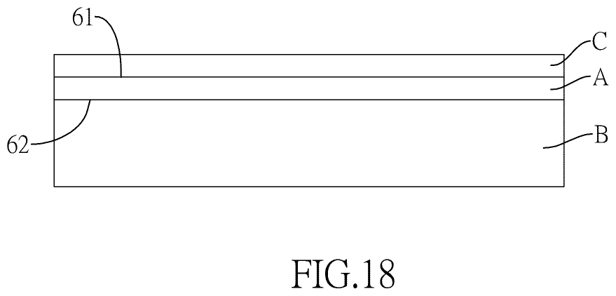

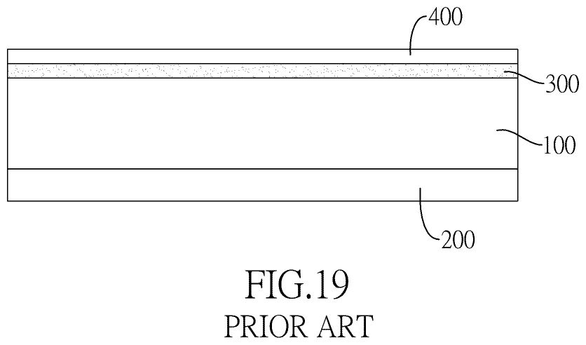

With reference to FIGS. 12 and 17, the light guide plate 10 includes the upper surface 103 and the lower surface 104, and the upper surface 103 is the light-emitting surface. The lower surface 104 forms multiple microstructures 105. A distribution density of the microstructures 105 decreases from a central position 106 of the light guide plate 10 toward an edge of the light guide plate 10.

The microstructures 105 disrupt the total internal reflection of light within the light guide plate 10, allowing the light to be emitted from the upper surface 103.

In general, a light intensity at an entrance of the light is the highest point on the light guide plate 10, and the light intensity at a reverse point of the entrance of the light is the lowest point on the light guide plate 10. Therefore, in order to make the light evenly emitted from the entire light guide plate 10, the microstructure 105 generally adjusts the distribution density in a curve manner. For example, in the fourth and fifth embodiments, the light enters the light guide plate 10 from the two opposite first sides 101 and the two opposite second sides 102. Therefore, the light intensity at the central position 106 of the light guide plate 10 is the lowest. The distribution density of the microstructures 105 gradually decreases from the central position 106 of the light guide plate 10 to the edge of the light guide plate 10, so that the light can be evenly emitted from the light guide plate 10.

In addition, the microstructure 105 may be dots or other patterns, such as a prism pattern, a strip pattern, or a grid pattern.

In summary, the present invention sets up different light sources in the backlight unit. The first light source group can output unfiltered normal first light in the first display mode (e.g., daytime mode), allowing the LCD panel A to output full-color images. The second light source group, in the second display mode (e.g., night vision mode), emits the filtered second light to the light guide plate 10. In the second light, the near-infrared light (wavelengths 610 nm~930 nm) is filtered out. Therefore, when the LCD panel A is used for night vision imaging, the LCD panel A will not be affected by the near-infrared light in the light source.

Moreover, the dual-mode LCD may further include a capacitive touch panel (CTP) C. The CTP C is attached with the front side 61 of the LCD panel A for detecting a touch input from a user. Namely, the dual-mode LCD may be a touchscreen.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A dual-mode liquid crystal display (LCD) compatible with night vision function, comprising:
an LCD panel, comprising a front side and a rear side;
a backlight unit, mounted on the rear side of the LCD panel, the backlight unit comprising:
at least one light guide plate, comprising a light-emitting surface;
wherein the light-emitting surface faces the rear side of the LCD panel;
a first light source group, configured to emit a first light towards the at least one light guide plate in a first display mode;
a second light source group, configured to emit a second light towards the at least one light guide plate in a second display mode; wherein a near-infrared light in the second light is filtered out.

2. The dual-mode LCD compatible with night vision function as claimed in claim 1, wherein the at least one light guide plate of the backlight unit is a flat light guide plate;
wherein one side of the flat light guide plate is a light incident side;
wherein the first light source group comprises a plurality of first light-emitting elements, and the first light-emitting elements are mounted near the light incident side;
wherein the second light source group comprises a plurality of second light-emitting elements, and the second light-emitting elements are mounted near the light incident side, and the second light-emitting elements are arranged alternately with the first light-emitting elements.

3. The dual-mode LCD compatible with night vision function as claimed in claim 1, wherein the at least one light guide plate of the backlight unit comprises:
a first light guide plate; wherein the first light guide plate is a wedge-shaped light guide plate, and comprises a light incident side, a first surface, and a first inclined surface; wherein the first surface is opposite to the first inclined surface; wherein the first surface forms a plurality of dots; wherein the first inclined surface is a light-emitting surface of the first light guide plate, and the first inclined surface faces the LCD panel;
a second light guide plate; wherein the second light guide plate is a wedge-shaped light guide plate, and comprises a light incident side, a second surface, and a second inclined surface; wherein the second surface is opposite to the second inclined surface; where the second inclined surface forms a plurality of dots, and the second inclined surface faces the first inclined surface; wherein the second surface is a light-emitting surface of the second light guide plate, and the second surface faces the LCD panel;
wherein the first light source group comprises a plurality of first light-emitting elements, and the first light-emitting elements are mounted near the light incident side of the first light guide plate;
wherein the second light source group comprises a plurality of second light-emitting elements, and the second light-emitting elements are mounted near the light incident side of the second light guide plate.

4. The dual-mode LCD compatible with night vision function as claimed in claim 3, wherein the first inclined surface forms a plurality of first microprisms, and each of the first microprisms comprises:
a base surface; wherein the base surface is coplanar with the first inclined surface of the first light guide plate;
a first prism surface, facing the light incident side of the first light guide plate; wherein a first angle is formed between the first prism surface and the base surface;
a second prism surface, facing away from the light incident side of the first light guide plate; wherein a second angle is formed between the second prism surface and the base surface, and the second angle is greater than the first angle;
wherein the second surface forms a plurality of second microprisms, and each of the second microprisms comprises:
a base surface coplanar with the first surface of the second light guide plate;
a first prism surface, facing the light incident side of the second light guide plate; wherein an angle is formed between the first prism surface and the base surface of the second microprism;
a second prism surface, facing away from the light incident side of the first light guide plate; wherein an angle is formed between the second prism surface and the base surface of the second microprism, and the angle between the first prism surface and the base surface is equal to the angle between the second prism surface and the base surface of the second microprism.

5. The dual-mode LCD compatible with night vision function as claimed in claim 1, wherein the at least one light guide plate of the backlight unit is a flat light guide plate;
wherein one side of the flat light guide plate is a light incident side;
wherein the first light source group comprises a plurality of first light-emitting elements, and the first light-emitting elements are mounted near the light incident side;
wherein the second light source group comprises a plurality of second light-emitting elements, and the second light-emitting elements are mounted near the light incident side;
wherein the first light-emitting elements and the second light-emitting elements are arranged in two rows.

6. The dual-mode LCD compatible with night vision function as claimed in claim 5, wherein the first light-emitting elements are arranged below the second light-emitting elements.

7. The dual-mode LCD compatible with night vision function as claimed in claim 1, wherein the at least one light guide plate of the backlight unit is a polygonal flat light guide plate, and the polygonal flat light guide plate comprises two opposite first sides and two opposite second sides;
wherein the first light source group comprises a plurality of first light-emitting elements, and the first light-emitting elements are mounted near the two opposite first sides;
wherein the second light source group comprises a plurality of second light-emitting elements, and the second light-emitting elements are mounted near the two opposite second sides.

8. The dual-mode LCD compatible with night vision function as claimed in claim 7, wherein the two opposite first sides and the two opposite second sides are respectively concaved to a central position of the light guide plate, and the two opposite first sides and the two opposite second sides are each in an arc shape.

9. The dual-mode LCD compatible with night vision function as claimed in claim 7, wherein the polygonal flat light guide plate comprises an upper surface and a lower surface, and the upper surface is a light-emitting surface of the polygonal flat light guide plate;
wherein the lower surface forms multiple microstructures, and a distribution density of the microstructures decreases from a central position of the polygonal flat light guide plate toward an edge of the polygonal flat light guide plate.

10. The dual-mode LCD compatible with night vision function as claimed in claim 7, wherein the polygonal flat light guide plate is an octagonal flat guide plate.

11. The dual-mode LCD compatible with night vision function as claimed in claim 2, wherein each of the first light-emitting elements is a white light-emitting diode (LED);
wherein each of the second light-emitting elements comprises a white LED and a filter, and the filter is mounted on a light-emitting surface of the white LED of each of the second light-emitting elements.

12. The dual-mode LCD compatible with night vision function as claimed in claim 11, wherein the first display mode is a daytime mode;
wherein the second display mode is a night vision mode.

13. The dual-mode LCD compatible with night vision function as claimed in claim 12, wherein a wavelength of the near-infrared light is in a range of 610 nm to 930 nm.

14. The dual-mode LCD compatible with night vision function as claimed in claim 1, wherein the first display mode and the second display mode are operated at different times.

15. The dual-mode LCD compatible with night vision function as claimed in claim 1, further comprising:
a capacitive touch panel (CTP), attached with the front side of the LCD panel.
